(19) United States
(12) Patent Application Publication
(10) Pub. No.: US 2007/0099478 A1
(43) Pub. Date: May 3, 2007

(54) Polymer sheet having surface relief features

(76) Inventors: Joel M. Petersen, Valley Village, CA (US); Christopher C. Rich, Rancho Palos Verdes, CA (US); Jun Qi, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/266,029

(22) Filed: Nov. 3, 2005

(51) Int. Cl. H01R 11/20

(52) U.S. Cl. 439/422

(57) ABSTRACT

Certain embodiments include a method of manufacturing a polymer sheet having surface relief features. In this method, a layer of pre-polymerized material is provided. A plurality of spatially separated locations on the curable material is exposed to ultraviolet light such that the material locally cures at those locations. The curable material is exposed again such that regions outside those locations are also cured. The curing produces the polymer sheet having the surface relief features; the relief features being at those locations.

### BACKGROUND

1. Field of the Invention

The present invention relates to the manufacture of polymer sheets having surface relief features.

2. Description of the Related Art

Polymer sheets can be employed in a wide variety of applications including optical elements. Polymer sheets may be used, for example, in displays such as liquid crystal displays (LCDs) for computers, cell phones, personal digital assistants (PDAs), games, automobile and navigational instrumentation, and for other applications. Such displays may include a liquid crystal spatial light modulator to produce an image pattern. These displays may further comprise a system for backlighting the spatial light modulator. To control the direction of light propagating from the spatial light modulator, the display may also include prismatic films between the spatial light modulator and the backlighting system. Such a prismatic film comprises plastic having a surface that includes a plurality of grooves that form facets of small prisms. These small prisms or micro-prisms limit the angle of light transmitted through the prismatic film and can be used to establish the field-of-view of the display. The array of micro-prisms may also increase the brightness of the display by recycling light back toward the backlighting system if the light is directed outside the desired field-of-view. However, when a prismatic film comprising rows or columns of prisms structures is used with a spatial light modulator comprising pixels also arranged in rows and columns, the rows or columns of prisms can interfere with the rows and columns of the spatial light modulator and produce a Moiré pattern, an interference pattern seen when viewing the display screen. Adding a diffuser can help to reduce the Moiré effect. Similarly, introducing diffusing surface features on the surface of the prismatic film can also attenuate the Moiré effect.

Polymer prismatic films may be fabricated using a metal master having surface relief structure disposed thereon. The surface relief structure may be used to mold, extrude, emboss, or otherwise form prismatic surface structure in a polymer sheet. The surface relief structure on the master may be formed by cutting grooves in the master using diamond turning. Diamond turning, however, has limitations. Diamond turning techniques are not able to provide diffusing relief structures having certain shapes, such as diffusing features that are elliptical, in a random fashion superimposed on prismatic surface structure. This limitation in the formation of the master extends to the product produced by the master. Accordingly, a diamond turned master has difficulty forming randomized and elliptical surface features on prismatic films.

What is needed therefore are alternative methods for manufacturing surface relief structures in polymer sheets.

### SUMMARY

One embodiment of the invention comprises a method of manufacturing a polymer sheet having surface relief features. This method comprises depositing a layer of fluid over a first surface. The fluid comprises a pre-polymer material comprising monomers, oligomers, or a mixture of monomers and oligomers. The method further comprises first exposing a plurality of spatially separated locations on the fluid to light such that the pre-polymer material locally cures and substantially solidifies at the locations. A portion of the monomers, oligomers, or monomers and oligomers in the pre-polymer material migrates to the locations from regions outside the locations. The method also comprises a second exposure of the fluid comprising pre-polymer material such that the regions outside the locations are cured and substantially solidified. The curing produces the polymer sheet having the surface relief features. The surface relief features are at the locations.

Another embodiment of the invention comprises a method of manufacturing a polymer sheet having surface relief features. This method comprises providing a layer of fluid comprising curable material. This layer of fluid has a surface. The method further comprises altering the height of the surface of the layer of fluid at spatially separated locations relative to the surrounding surface such that the locations correspond to the position of the surface relief features. The altering comprises curing the curable material at the locations differently than the surrounding surface.

Another embodiment of the invention comprises a method of manufacturing a polymer sheet having a contoured surface. This method includes providing a layer of curable material. A first set of surface relief structures is formed in the layer by contact. A second set of surface relief features is produced in the layer by optically curing the curable material. The curing of material at locations corresponding to the surface relief features is different than the curing outside of the locations. The first set of surface relief structures and the second set of surface relief features are selected to provide different optical effects when corresponding surface relief structures and surface relief features are formed in a transmissive medium or reflective surface.

Another embodiment of the invention comprises a method of manufacturing a polymer sheet having surface relief features. This method comprises providing a layer of curable material, first exposing a plurality of spatially separated locations on the curable material to electromagnetic radiation such that the material locally cures at the locations, and second exposing the curable material such that regions outside the locations are cured. The curing produces the polymer sheet having the surface relief features. The surface relief features are at the locations.

Another embodiment of the invention comprises a method of manufacturing a polymer sheet having surface relief features. The method comprises providing a layer of curable material having a surface and altering the height of the surface of the layer at spatially separated locations relative to the surrounding surface. The locations correspond to the position of the surface relief features. The altering comprises curing the material at the locations differently than the surrounding surface.

### BRIEF DESCRIPTION OF THE DRAWINGS

FIGS. 1A and 1B are schematic drawings that illustrate a photo-polymerization process wherein a pre-polymerized material is cured with light to obtain a polymer sheet. FIG. 1C shows a free volume region produced by a reduction in volume of the pre-polymerized material with polymerization.

FIGS. 2A-2D are schematic drawings that illustrate a two-stage photo-polymerization process wherein first, a localized portion of a pre-polymerized material is cured by propagating light through an aperture in a mask, and second, surrounding portions of the pre-polymerized material are cured with the mask removed to obtain a surface feature.

FIG. 3 is a surface plot on x, y, and z axes showing the profile of a surface feature produced by the photo-polymerization process shown in FIGS. 2A-2D as modeled for a mask having a circular aperture.

FIGS. 4A-4C are schematic drawings that illustrate a photo-polymerization process involving contacting a pre-polymerized material with a surface having surface relief structure thereon and curing the pre-polymerized material with light to obtain a polymer sheet having surface structure thereon.

FIGS. 5A-5C are schematic drawings that illustrate a two-stage photo-polymerization process that involves first propagating light through a mask to polymerize localized regions of the pre-polymer material while contacting the pre-polymerized material with a surface having surface relief structure thereon and removing the mask and further curing the pre-polymerization material.

FIGS. 6A-6C are schematic drawings that illustrate a photo-polymerization process similar to that shown in FIGS. 5A-5C used to form elliptical surface features disposed on a faceted surface.

FIGS. 7A and 7B are schematic drawings that illustrate a replication process wherein the faceted surface structure having elliptical features thereon is used to form a prismatic structure with elliptically shaped diffusing features thereon.

FIG. 8 is a schematic drawing showing the prismatic structure in a display further comprising a spatial light modulator that is backlit.

FIG. 9A is a schematic drawing that illustrates sandwiching a pre-polymerized liquid between a carrier and a rigid surface using a roller.

FIG. 9B is a schematic cross-sectional view that shows light propagating through a mask to cure the pre-polymerized material sandwiched between the carrier and the rigid surface depicted in FIG. 9A.

FIG. 9C is a cross-sectional view schematically depicting a blanket UV exposure with the mask removed to cure the pre-polymerized material sandwiched between the carrier and the rigid surface thereby forming a polymer layer.

FIG. 9D is a cross-sectional view that schematically illustrates separating the carrier and polymer layer formed thereon from the rigid surface.

### DETAILED DESCRIPTION OF CERTAIN PREFERRED EMBODIMENTS

A polymer sheet may be fabricated by curing curable material using light or electromagnetic radiation. This curable material may comprise a pre-polymerized material and the light may be used to polymerize this pre-polymerized material. This pre-polymer material may comprise a fluid or liquid.

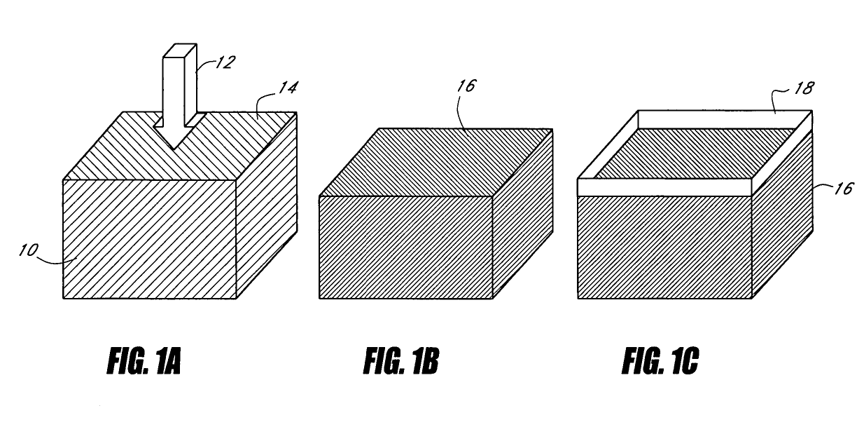

FIG. 1A shows an exemplary photo-polymerization process wherein a pre-polymerized material 10 is exposed to electromagnetic radiation (represented by arrow 12) to cure the pre-polymerized material. The electromagnetic radiation may comprise, for example, ultraviolet (UV) light or actinic light. The pre-polymer material 10 may comprise monomers, oligomers, or a mixture of monomers and oligomers. The pre-polymer material 10 also includes a photo-initiator. FIG. 1 shows a blanket exposure of the pre-polymer material 10 to ultraviolet (UV) light. A surface 14 of the pre-polymer material 10 is completely exposed to the UV light. Exposure of this pre-polymerized material 10 to ultraviolet light causes the monomer and oligomer molecules to crosslink to form a polymer network.

FIG. 1B shows a polymerized sheet 16 produced by exposing the pre-polymerized material to UV light to cure the pre-polymerized material. This polymerized sheet 16 may comprise a plastic sheet in some embodiments. FIG. 1B is a schematic drawing that shows the polymerized sheet 16 as thick and relatively narrow. This sheet 16 may, however, be thinner and wider. More generally this sheet 16 may have any shape and any dimensions. The sheet 16 may comprise, for example, a film, a plate, or a thicker component and may be curved or shaped.

The polymer sheet 16 may have a smaller volume than the pre-polymerized material. In general, polymerization results in the shrinkage of volume. FIG. 1C illustrates this shrinkage and the resultant generation of a free volume region 18.

The photo-polymerization process may be different. in different embodiments. For example, a wide variety of pre-polymer materials can be employed. Different photo-intiators that are responsive to different wavelengths of light may also be used. Accordingly, different wavelengths of light may be used to cure the pre-polymerized material 10.

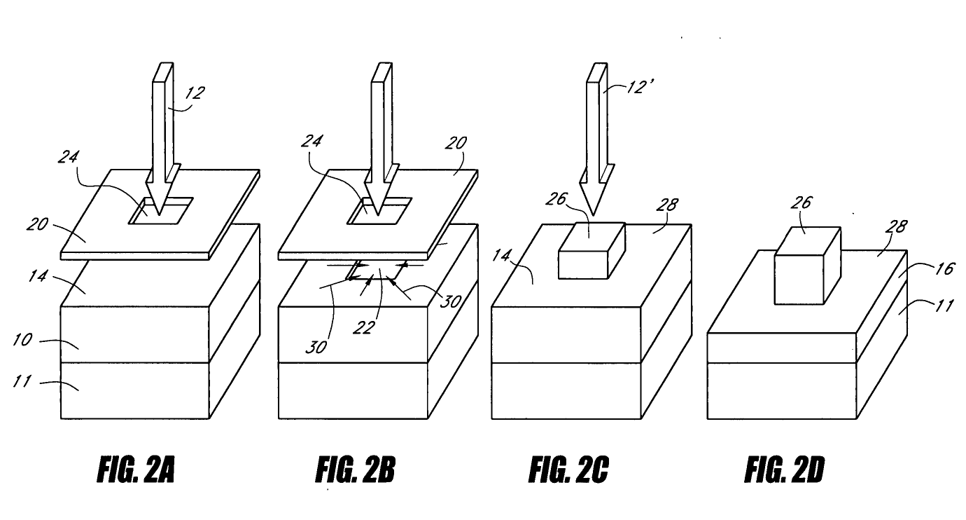

In another embodiment shown in FIGS. 2A and 2B, a mask 20 is used to expose a portion 22 of the surface 14 of the pre-polymerized material 10 formed on a substrate 11 to UV radiation. The mask 20 may comprise a material that is substantially opaque to the UV light and thus blocks the UV light. The mask 20 has an aperture 24 therein through which some of the UV light passes. The aperture 24 may comprise a physical opening in the mask 20 or may comprise material that is substantially optically transmissive to the UV light. The mask 20 thereby provides spatial modulation of the UV light. In FIGS. 2A and 2B, the aperture 24 and the exposed portion 22 of the pre-polymer material are shown as square, however, the aperture and the exposed portion may have any shape. The mask 20 may comprise, for example, a lithographic films formed, e.g., by a photographic process that yields patterned black portions that block light or a photomask comprising, e.g., a glass or quartz plate with patterned chrome, aluminum, or other metal portions that block light, although other types of masks may be used.

The exposed portion 22 of the pre-polymerized material 10 is polymerized. As described above, monomers and/or oligomers in the pre-polymerized material 10 are cross-linked to form polymer. In various embodiments wherein the pre-polymerized material 10 comprises a fluid or a liquid, the exposed portions 22 of the material 10 solidifies. A localized surface relief feature 26 is thereby formed.

As depicted in FIG. 2C, the mask 20 is removed and the surface 14 of the pre-polymerized material 10 is again exposed to UV light (as represented by arrow 12′). Both the previously exposed portion 22 and area surrounding 28 the previously exposed portion are further exposed to UV light in this “blanket” exposure. In other embodiments, the surrounding area 28 may be exposed without exposing the localized surface relief feature 26 although a blanket exposure may be easier to perform.

The surrounding area 28, here the remaining portions of the pre-polymerized material 10, are polymerized with the blanket exposure as illustrated in FIG. 2D. In various embodiments wherein the pre-polymerized material 10 comprises a fluid or a liquid, the surrounding area 28 also solidifies. The result is a polymer sheet 16 having a surface 14 that includes the localized surface relief feature 26 disposed thereon. As described above, FIG. 2D is a schematic drawing that shows the polymerized sheet 16 as thick and narrow. This sheet 16, however, may be relatively thin. More generally, this sheet 16 may have any shape and any dimensions. The sheet 16 may comprise, for example, a film, a plate, or a thicker component, which may be curved or shaped.

In other embodiments, the mask 20 may be above or below (on either side of) the pre-polymerized material 10 and substrate 11 and the UV light can be directed from either side as well. Similarly, the UV light used in the second exposure may be from either side (e.g., above or below) the pre-polymerized material 10 and the substrate 11. Accordingly, in some embodiments, the substrate 11 is substantially optically transmissive to the light used to cure the pre-polymerized material 10. In some embodiments, the mask may contact the pre-polymerized material.

Advantageously, the localized surface relief feature 26 is formed by exposing the pre-polymerized material 10 to light, which in certain preferred embodiments, creates a hardened surface feature without the need for an added step of developing, for example, without exposure to a solvent such as an alkaline solution to remove un-exposed pre-polymerized material 10 prior to the second exposure. Similarly, the surrounding area 28 is exposed and hardened by exposing the pre-polymerized material 10 in the surrounding area to light, again without the need for an additional step of developing, for example, without the need for rinsing with a solvent such as an alkaline solution. Moreover, in certain preferred embodiments, the hardened polymer sheet 16 is formed without the additional step of baking, for example, to solidify and/or harden the pre-polymerized mixture in the localized surface relief feature 26 or the surrounding area 28.

Without subscribing to any particular scientific theory, one possible explanation of this process is that with the mask 20 in place, exposure of the localized portion 22 of the pre-polymerized material 10 causes polymerization of monomers and/or oligomers in the localized portion and draws additional monomers and/or oligomers from the surrounding area 28. This migration of monomers and/or oligomers from the surrounding area 28 into the localized exposed region 22 is represented by arrows 30.

The shape of the surface 14 may not be exactly the same as illustrated in FIGS. 2C and 2D. In certain embodiments, the shape and size of the localized surface relief feature 26 is correlated to parameters, such as the size and shape of the aperture 24 in the mask 20, the mobility of monomers and/or oligmers, the thickness of the pre-polymerized material 10, and the UV radiation. For example, the height of the surface relief structure 26 can be dependent on these parameters.

According to one theory, during the first exposure, a polymer network as well as free volume forms in the localized exposed portion 22. A chemical potential gradient is generated between the localized exposed portion 22 and the surrounding unexposed area 28. As a result, the monomer and/or oligomer molecules migrate to the localized exposed area 24 through a diffusion process and the free volume counter-diffuses to the surrounding unexposed area 28. After the first photo-polymerization, the localized exposed area 22 may have a higher weight per unit area as molecules migrated to the localized exposed area and free volume is produced in the surrounding unexposed area 28. With the second exposure, wherein the mask 10 is removed, the unreacted monomer and/or oligomer mixture polymerizes and the surrounding region 28 shrinks producing more free volume. Consequently, the surface relief structure 26 formed with the first exposed area is higher than the surrounding area 28.

The photo-polymerization and polymer migration process can be modeled using reaction-diffusion equations:

$$\begin{matrix}\frac{\partial {ϕ}_{m}}{\partial t} = - γ {I}^{α} {ϕ}_{m} + ∇ \cdot [ D ∇ {ϕ}_{m} ] & ( 1 ) \\ \frac{\partial {ϕ}_{p}}{\partial t} = ( 1 - β ) γ {I}^{α} {ϕ}_{m} & ( 2 )\end{matrix}$$

where φₘ is the concentration of monomers and/or oligomers, t is time, γ is the reaction rate, which depends on the concentration of photo-initiator and reactivity of monomers and/or oligomers, I is the local light intensity, α is the exponential component for polymerization, D is the effective diffusion constant, φₚ is the polymer concentration, and β is the shrinkage factor. In this model, the migration of polymer is neglected since the molecular weight of polymer is much higher than that of monomers and/or oligomers and, consequently, the migration of polymer is much slower than that of monomers and/or oligomers.

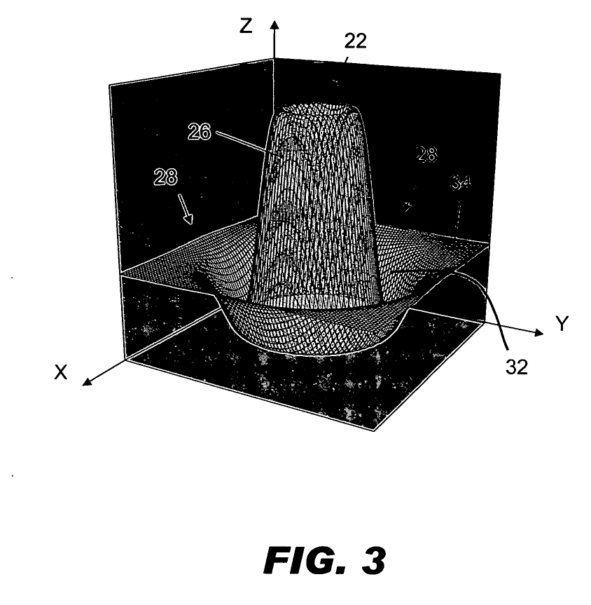

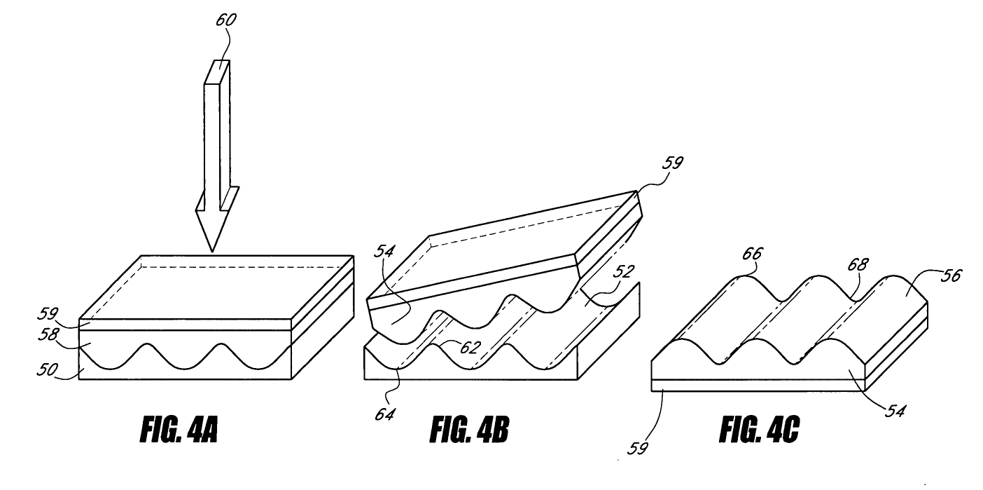

FIG. 3 is a plot of the localized surface relief feature 26 calculated using the diffusion equations (1) and (2) for a mask having a circular aperture 24. The surface relief feature 26 is plotted on x, y, and z axes which correspond to lateral spatial location (x, y) and surface height (z) in arbitrary units. The plot shows the portion 22 exposed by light propagating through the aperture 24 as well as the surrounding area 28. Inner and outer regions 32, 34 of the surrounding area 28 close to and farther away, respectively, from the localized surface relief feature 26 are shown. In this plot, the height of the localized surface relief feature 26 is higher than both regions 32 and 34 of surrounding area 28. The height of the inner region 32 of the surrounding area 28 is lower than that height in the z direction of the outer region 34. This profile may indicate that during the photo-polymerization, the monomer and/or oligomer migrates from the surrounding area 28 to the locally exposed portion 22 to form the surface relief feature 26.

Migration of the monomer and/or oligomer is one theory for explaining the formation of the surface relief feature 26 as a result of the photo-polymerization process shown in FIGS. 2A-2D, which involved two exposure steps. Other scientific explanations, however, are also possible.

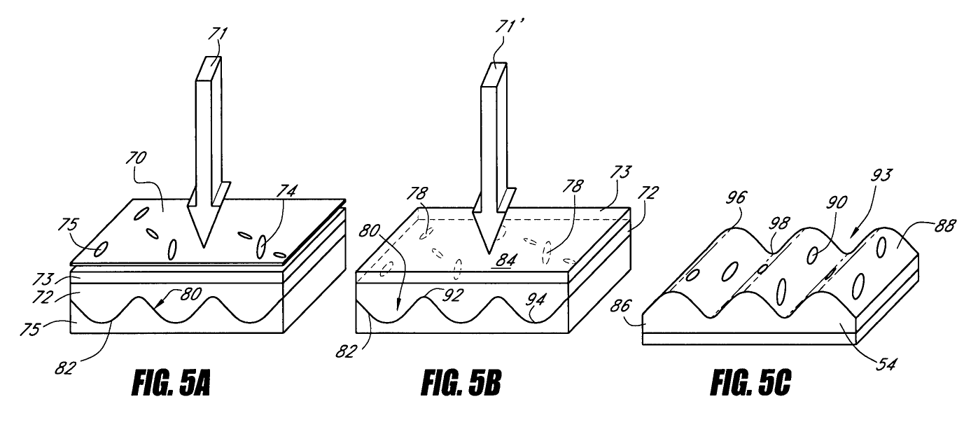

As shown in FIGS. 4A-4C, a tool 50 having surface relief structure 52 (see FIG. 4B) formed thereon can be used to form a polymer sheet 54 that consequently also has surface relief structure 56 (see FIG. 4C). The surface relief structure 56 in the polymer sheet 54 will be the negative or inverse of the surface relief structure 52 of the tool 50.

FIG. 4A shows a pre-polymerized material 58 disposed on the tool 50. Injection gravier coating, slot die coating, or other methods may be used to introduce the pre-polymerized material 58 to the tool 50 such that the tool contacts the pre-polymerized material. A carrier substrate 59 is disposed over the pre-polymerized material 58. The pre-polymerized material 58 is exposed to ultraviolet light, represented by arrow 60, to cure the pre-polymerized material. The pre-polymerized material 58 is thereby polymerized to form the polymer sheet 54.

In the embodiment shown in FIG. 4A, the UV is propagated through the carrier substrate 59 and to the pre-polymerized material 58. Accordingly, the carrier substrate 59 may be substantially optically transmissive to UV light or any other light used to cure the pre-polymerized material 59. In other embodiments, the light may be propagated through the tool 50 to cure the pre-polymerized material 58. In such cases, the tool 50 may be substantially optically transmissive to the wavelength of light used to cure the pre-polymerized mixture 58.

The polymer sheet 54 can be separated from the tool 50 as shown in FIG. 4B. The tool 50 may comprise metal that has been diamond turned to provide the surface relief structure 52 therein. Other types of tools 50, which may comprise other materials and may be fabricated by other methods including photolithography and holography, may also be used. In the example shown, the tool 50 is corrugated. The tool 50 has a plurality of grooves formed therein. As a result, the surface relief structure 52 has peaks 62 and valleys 64, ridges and depressions, highs and lows.

Similarly, the polymer sheet 54 fabricated from the tool 50 comprises a plurality of grooves; see FIG. 4C. This surface relief structure 56 too has peaks 66 and valleys 68, ridges and depressions, highs and lows. The peaks 66 and valleys 68 of the polymer sheet 54, however, respectively match the valleys 64 and peaks 62 of the tool 50 from which these peaks 66 and valleys 68 were formed. As described above, the surface relief structure 56 on the polymer sheet 54 is the inverse or negative of the surface relief structure 52 on the tool 50.

This process is referred to as a replication process even though the negative or inverse of the surface relief structure 52 of the tool 52 are formed in the polymer sheet 54. The process can be repeated using the polymer sheet 54 as a tool in the formation of a second polymer sheet (not shown) having surface relief structure. The surface relief structure of this second polymer sheet (not shown) will be the same as the original tool 50 and not the inverse. Accordingly, virtually exact copies of the tool 50 can be made by the replication process. The replication process can be repeated any number of times alternately producing negatives (inverse) and positives (identical copies) of the tool 50. Any of the copies may be used as a tool or master to produce a plurality of polymer sheets (e.g. product). In other embodiments, for example, this first polymer sheet 54 can be used as a tool, a master, to produce a plurality of polymer sheets (e.g., product) that are replicas of the original tool 50. In still other embodiments, the second polymer sheet (not shown) can be used as a tool, a master, to produce a plurality of polymer sheets (e.g., product). Either or both of the first polymer sheet 54 or the second polymer sheet (not shown) or any other copies may be metalized in certain embodiments.

The double exposure process shown in FIGS. 2A-2D may be used to provide the ability to further modify the surface relief structure 56 on the polymer sheet 54 shown in FIG. 4C. A more a sophisticated surface relief structure can thereby be formed.

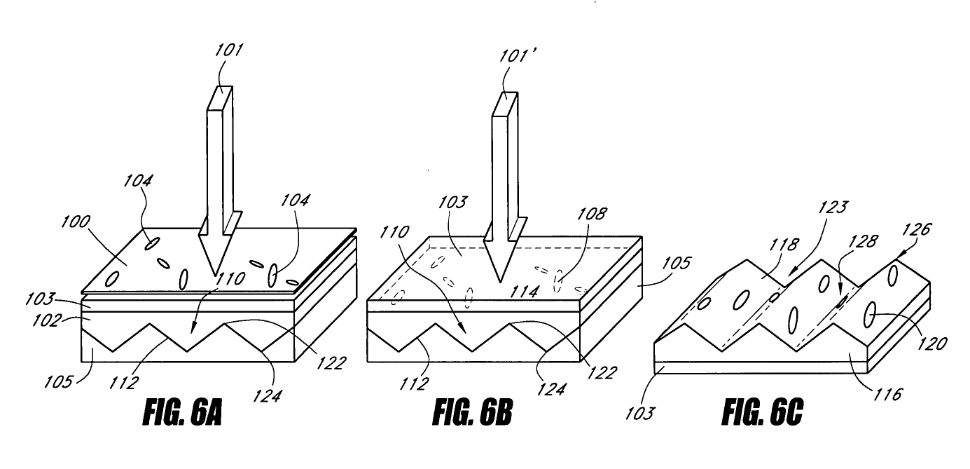

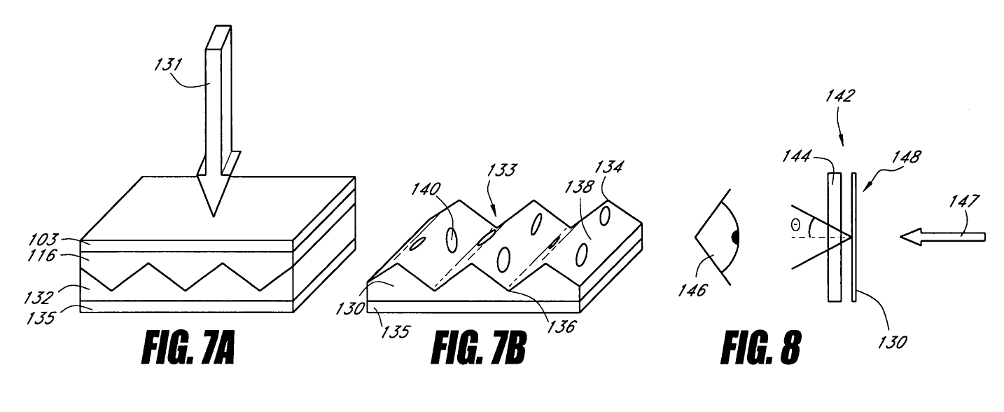

FIGS. 5A-5C illustrates one embodiment of such a process. As shown in FIG. 5A, a mask 70 is used to expose spatially separated locations 78 (see FIG. 5B) on a pre-polymerized material 72 to UV radiation (represented by arrow 71). As shown, a carrier substrate 73 is disposed over the pre-polymerized material 72.

As discussed above, the mask 70 may comprise a material that is substantially opaque to the UV light and thus blocks the UV light. The mask 70 includes a plurality of separate apertures 74 through which some of the UV light passes. The apertures 74 may comprise a physical opening in the mask 70 or may comprise material that is substantially optically transmissive to the UV light. The mask 70 thereby provides spatial modulation of the UV light. In FIGS. 5A and 5B, the apertures 74 are shown as elliptical. Similarly, the exposed portions 78 (shown in FIG. 5B) of the pre-polymer material are also elliptical. The aperture 74 and the exposed portions 78 may have any shape. The mask 70 may comprise, for example, lithographic films or photo-masks, although other types of masks may be used.

The exposed portions 78 of the pre-polymerized material 72 (shown in FIG. 5B) are polymerized. As described above, monomers and/or oligomers in the pre-polymerized material 72 are cross-linked to form polymer.

In the embodiment depicted in FIG. 5A, the UV light is propagated through the carrier substrate 73 and to the pre-polymerized material 72. Accordingly, the carrier substrate 73 may be substantially optically transmissive to UV light or any other light used to cure the pre-polymerized material 72. In other embodiments, the mask 70 may be below the tool 75. Accordingly, the tool 75 may be between the mask 70 and the pre-polymerized material 72. The light may be propagated through the mask 70 and the tool 75 to cure the pre-polymerized material 72. In such cases, the tool 75 may be substantially optically transmissive to the wavelength of light used to cure the pre-polymerized material 72. The mask 70 may contact the carrier substrate 73, pre-polymerized material 72 or tool 75 depending on the configuration.

FIGS. 5A and 5B show the pre-polymerized material 72 formed over a tool 75. As described above, a carrier substrate 73 is disposed over the pre-polymerized material 72. Gravier coating, slot die coating, or other methods may be used to introduce the pre-polymerized material 72 to the tool 50 such that the tool contacts the pre-polymerized material.

The tool 75 has surface relief structures 80. In particular, the tool 75 shown in FIGS. 5A and 5B has an undulating surface 82. The tool 75 may comprise, for example, metal that has been cut using, e.g., diamond turning such as single point diamond turning, as described above. Other methods of forming the tool, such as lithography and holography, may also be used.

The mask 70 is removed, as shown in FIG. 5B, and the polymer and remaining pre-polymerized material 72 is exposed to UV light (as represented by arrow 71′). Both the previously exposed portions 78 and area 84 surrounding the previously exposed portions are further exposed to UV light in this “blanket” exposure. In other embodiments, the surrounding area 84 may be exposed without exposing the previously exposed portions 78 although a blanket exposure may be easier to perform.

The surrounding area 84, here the remaining portions of the pre-polymerized material 72, are polymerized with the blanket exposure. The result is a polymer sheet 86 shown in FIG. 5C having a surface 88 that includes the localized surface relief features 90 disposed thereon. FIG. 5C shows the polymer sheet 86 separated from the tool 75.

In other embodiments, the light represented by arrow 71′ is propagated through the tool 75 to the pre-polymerized material 72. In such embodiments, the tool 75 may be substantially optically transmissive to UV light or any other wavelength used to cure the material 72.

As described above, the tool 75 is corrugated in the embodiment shown; see FIG. 5A. In particular, the tool 75 has a plurality of grooves formed therein. The surface relief structure 80 in the tool 75 includes a plurality of peaks 92 and valleys 94, ridges and depressions, highs and lows; see FIG. 5B.

Similarly, the polymer sheet 86 fabricated from the tool 75 comprises a plurality of grooves; see FIG. 5C. The surface 88 has surface relief structure 93 comprising peaks 96 and valleys 98, ridges and depressions, highs and lows. The peaks 96 and valleys 98 of the polymer sheet 86, however, respectively match the valleys 94 and peaks 92 of the tool 75 from which these peaks 96 and valleys 98 were formed. As described above, the surface relief structure 93 on the polymer sheet 86 is the inverse or negative of the surface relief structure 80 on the tool 75. Accordingly, in this process, the negative or inverse of the surface relief structure 80 of the tool 75 are formed in the polymer sheet 86.

Additionally, the surface relief features 90 are formed on the surface 88 of the polymer sheet 86. In the embodiment shown in FIG. 5C, the surface relief features 90 comprise a plurality of elliptically shaped features, however, the shape may be different. For example, circular features may be used. Also, different shaped features may be included on the same sheet 86. The shapes may be irregular. The size (e.g., height and/or lateral dimensions) and orientation may also vary from that shown in FIG. 5C. The distribution of the surface relief features 90 may be different as well. The features 90 are spatially separated from each other. In certain embodiments, at least a portion of the surface relief features 90 are touching. (In some embodiments, most of the surface 88 is exposed using the mask 70 whereas only a portion is unexposed in the initial exposure step. After subsequent exposure the remainder may be exposed. The result is that the surface 88 includes a plurality of regions with reduced size in comparison with the remainder of the surface.)

The process can be repeated using the polymer sheet 86 as a tool in the formation of a second polymer sheet (not shown) having surface relief structure. The replication process can be repeated any number of times alternately producing negatives (inverse) and positives (identical copies) of the second polymer sheet. In some embodiments, one of these negative or positive replicas may be used as a master for producing additional sheets (e.g. product). In other embodiments, this first polymer sheet (not shown) can be used as a tool, e.g., a master, to produce a plurality of polymer sheets (e.g. product). In still other embodiments, this second polymer sheet (not shown) can be used as a tool, e.g., a master, to produce a plurality of polymer sheets (e.g. product). Either or both of the first polymer sheet 86 or the second polymer sheet (not shown), as well as any copies thereof, may be metalized in certain embodiments. Accordingly, the processes herein may be used to form tools or products as well as intermediate structures.

As described above, FIG. 5C is a schematic drawing that shows the polymerized sheet 86 as thick and narrow. This sheet 86, however, may be thinner and wider. More generally this sheet 86 may have any shape and any dimensions. The sheet 86 may comprise, for example, a film, a plate, or a thicker component, which may be curved or shaped.

The processes described herein can be used to fabricate diffraction gratings and diffractive optical elements. Holograms and holographic optical elements may be formed. Diffusers, lens including microlenses, and other optical components may be fabricated. The optical components may be transmissive, reflective, or both transmissive and reflective. The optical components can reflect, refract, scatter, and/or diffract light. In some embodiments, the components produced by these processes are opaque. These processes need not necessarily be used to form optical components but can be used for other applications including those yet to be realized.

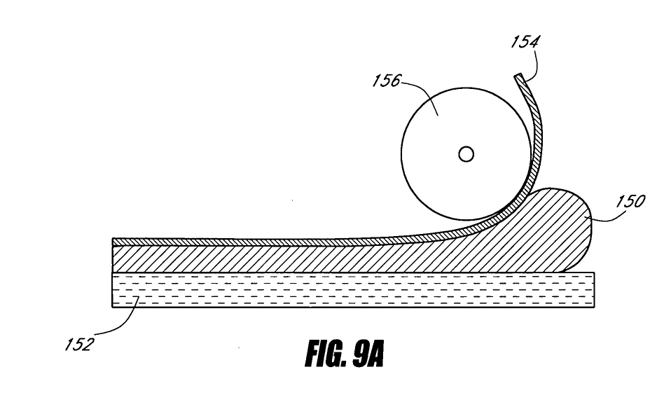

FIGS. 6A-6D illustrate how this multiple exposure process can be employed to fabricate a prismatic film for controlling propagation of light, for example, in an optical display. As discussed above, prismatic films may be used in displays such as LCD displays to control the direction of light propagating from the display. Such displays may include a liquid crystal spatial light modulator to produce an image pattern. These displays may further comprise a system for backlighting the spatial light modulator. The prismatic film may be disposed between the spatial light modulator and the backlighting system. The prismatic film may comprise plastic having a surface that includes a plurality of grooves that form facets of small prisms. These small prisms or micro-prisms limit the angle of light transmitted through the prismatic film and can be used to establish the field-of-view of the display. The array of micro-prisms may also increase the brightness of the display by recycling light back toward the backlighting system if the light is directed outside the desired field-of-view. However, when a prismatic film comprising rows or columns of prisms structures is used with a spatial light modulator comprising pixels also arranged in rows and columns, the rows or columns of prisms structures can interfere with the rows and columns of the spatial light modulator and produce a Moiré pattern, an interference pattern seen when viewing the display screen. Introducing diffusing surface features on the surface of the prismatic film can attenuate the Moiré effect. Accordingly, a prismatic film that in addition to grooves that form facets of the prisms may further include diffusing features that scatter or diffuse the light.

As shown in FIG. 6A, a mask 100 is used to expose spatially separated locations on a pre-polymerized material 102 to UV radiation (represented by arrow 101). As discussed above, the mask 100 may comprise a material that is substantially opaque to the UV light and thus blocks the UV light. The mask 100 includes a plurality of separate apertures 104 through which some of the UV light passes. In FIG. 6A and 6B, the apertures 104 are shown as elliptical. Similarly, exposed portions 108 (shown in FIG. 6B) of the pre-polymer material 102 are also elliptical. The apertures 104 and the exposed portions 108 (shown in FIG. 6B) may have any shape (including but not limited to circular).

In other embodiments, the light used to cure the pre-polymerized material 102 may be propagated through the tool 105. Accordingly, the mask 100 may be located on the other side of the pre-polymerized material 102 and the tool 105 may be substantially optically transmissive to UV light. Additionally, in certain embodiments where wavelengths other than UV are used for curing, the mask 100 may comprise material substantially opaque to the wavelength of light employed. Likewise, the mask 100 includes optical apertures through which the wavelengths may pass. The tool 105 may also be substantially optically transmissive to the light depending on the configuration.

The exposed portion 108 of the pre-polymerized material 102 is polymerized. As described above, monomers and/or oligomers in the pre-polymerized material 102 are cross-linked to form polymer.

FIGS. 6A and 6B show the pre-polymerized material 102 formed over a tool 105 having surface relief structures 110 suitable for the formation of prismatic films. Gravier coating, slot die coating, or other methods may be used to introduce the pre-polymerized material 102 to the tool 50 such that the tool contacts the pre-polymerized material. A substrate carrier 103 is formed on the pre-polymerized material 102. In embodiments where the light is propagated through the substrate carrier 103 to cure the pre-polymerized material 102, the substrate may be substantially optically transmissive to the wavelengths used for curing.

The tool 105 shown in FIGS. 6A and 6B has a grooved surface 112 comprising sloped or inclined substantially planar faces. The tool 105 may comprise, for example, metal that has been cut using, e.g., diamond turning such as single point diamond turning, as described above. Methods including lithography and holography may also be used in the formation of the tool 105. Other types of tools 105 may also be used, e.g., when light is to be propagated through the tool.

The mask 100 is removed, as shown in FIG. 6B, and the polymerized and pre-polymerized material 102 are exposed to UV light (as represented by arrow 101′). Both the previously exposed portions 108 and area 114 surrounding the previously exposed portions are exposed to UV light in this “blanket” exposure. In other embodiments, the surrounding area 114 may be exposed without exposing the previously exposed portions 108 although a blanket exposure may be easier to perform.

The surrounding area 114, here the remaining portions of the pre-polymerized material 102, are polymerized with the blanket exposure as illustrated in FIG. 6B. The result is a polymer sheet 116 shown in FIG. 6C having a surface 118 that includes the localized surface relief features 120 disposed thereon. FIG. 6C shows the polymer sheet 116 separated from the tool 105 and disposed on the carrier substrate 103.

As described above, the tool 105 is corrugated in the embodiment shown; see FIG. 6B. In particular, the tool 105 has a plurality of grooves formed therein. The surface relief structure 110 includes a plurality of peaks 122 and valleys 124, ridges and depressions, highs and lows.

Similarly, the polymer sheet 116 fabricated from the tool 105 comprises a plurality of grooves; see FIG. 6C. The grooves are defined by sloping or inclined substantially planar faces. The surface 118 of the polymer sheet 116 has surface relief structure 123 comprising peaks 126 and valleys 128, ridges and depressions, highs and lows. The peaks 126 and valleys 128 of the polymer sheet 116, however, respectively match the valleys 124 and peaks 122 of the tool 105 from which these peaks 126 and valleys 128 were formed. As described above, the surface relief structure 123 on the polymer sheet 116 is the inverse or negative of the surface relief structure 110 on the tool 105. Accordingly, in this process, the negative or inverse of the grooves of the tool 105 are formed in the polymer sheet 116.

Additionally, the surface relief features 120 are formed on the surface 118 of the polymer sheet 116. In the embodiment shown in FIG. 6C, the surface relief features 120 comprise a plurality of elliptically shaped features, however, shape may be different. For example, circular features may be used. Also, different shaped features may be included on the same sheet 86. The shapes may be irregular. The size (e.g., height and/or lateral dimensions) and orientation may also vary from that shown in FIG. 6C. The distribution of the surface relief features 120 may also be different as well. The features 120 are spatially separated from each other. In certain embodiments, at least a portion of the surface relief features 120 are touching. (In some embodiments, most of the surface 118 is exposed using the mask 100 whereas only a portion is unexposed in the initial exposure step. After subsequent exposure, the remainder may be exposed. The result is that the surface 118 includes a plurality of regions with reduced size in comparison with the remainder of the surface.)

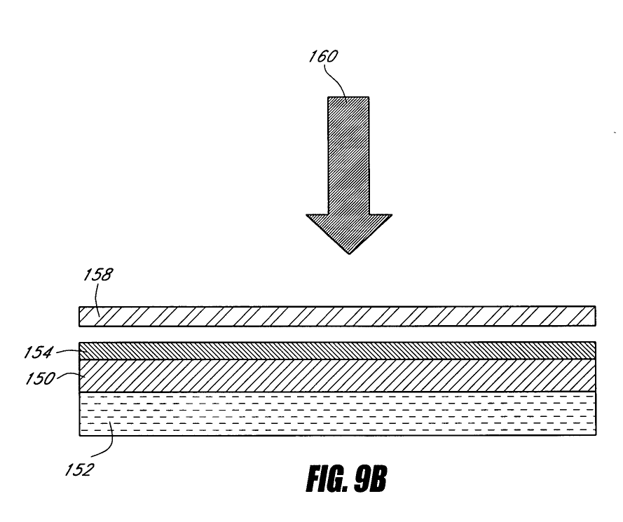

As shown in FIGS. 7A and 7B, the photo-polymerization process can be repeated using the polymer sheet 116 as a tool in the formation of a second polymer sheet 130 comprising a prismatic film for use, for example, in a display. FIG. 7A depicts the first polymer sheet 116 and a pre-polymerized material 132 in contact with the first polymer sheet. Pre-polymerized material 132 is disposed on a substrate 135. The surface 118 of the first polymer sheet 116 having surface relief structure 123 and localized surface relief features 120 is contacted to the pre-polymerized material 132.

The pre-polymerized material 132 is exposed to ultraviolet light, represented by arrow 131 to cure the pre-polymerized material. The pre-polymerized material 132 is thereby polymerized to form the second polymer sheet 130. In the embodiment shown, the first polymer sheet 116 including the carrier layer 103 is optically transmissive to wavelengths corresponding to the UV light such that the UV light can be transmitted through the first polymer sheet to expose the pre-polymerized material 132. In alternative embodiments, the pre-polymerized material 132 may be cured without directing light through the polymer sheet 116, for example, the light may be propagated from an opposite direction. The light may, for instance, be passed through the substrate 135 to the pre-polymerized material 132.

FIG. 7B shows the second polymer sheet 130 separated from the first polymer sheet 116. The second polymer sheet 130 has a surface having surface relief structure 133. The surface relief structure 133 of this second polymer sheet 130 will be the same as the surface relief structure 110 on the original tool 105 and not the inverse. In addition, the second polymer sheet 130 will have the inverse of the surface relief features 120 that are on the first polymer sheet 116. In particular, the surface relief structure 133 on the second polymer sheet 130 comprises a plurality of grooves defined by sloping or inclined substantially planar faces. These substantially planar faces comprise the facets of micro-prisms in the prismatic film. The facets of the micro-prisms will totally internally reflect a portion of the light incident on and propagating through the second polymer sheet 130. Conversely, another portion of the light that is incident on the second polymer sheet 130 is transmitted through the prismatic film and refracted by the facets of the micro-prisms into a limited range of angles as discussed more fully below. The surface relief structure 133 also has peaks 134 and valleys 136, which are the inverse of the valleys 128 and peaks 126 on the first polymer sheet 116.

The surface 138 of the second polymer sheet 130 further comprises surface relief features 140. These surface relief features 140 comprise diffusing structure that diffuses light transmitted through the second polymer sheet as discussed more fully below. In the embodiment shown in FIG. 7B, the surface relief features 140 comprise a plurality of elliptically shaped features, however, shape may be different. For example, circular features may be used. Also, different shaped features may be included on the same sheet 86. The shapes may be irregular. The size (e.g., height and/or lateral dimensions) and orientation may also vary from that shown in FIG. 7B. The distribution of the surface relief features 140 may also be different as well. The features 140 are spatially separated from each other. In certain embodiments, at least a portion of the surface relief features 140 are touching. (In some embodiments, most of the surface of the polymer sheet 130 includes regions with reduced size in comparison with the remainder of the surface.)

This first polymer sheet 116 can be used as a tool (e.g., a master) to produce a plurality of polymer sheets 130. These polymer sheets 130 may be product that is used, for example, in displays, as discussed more fully below. In other embodiments, the second polymer sheet 130 can be used as a tool (e.g., a master) to produce a plurality of polymer sheets. These polymer sheets may also be product that is used, for example, in displays, as discussed more fully below. In other embodiments, the replication process can be repeated any number of times producing surface relief structure that is the alternately negative (inverse) of and positive (identical copies) of the surface relief structure 110 on original tool 105. For example, the second polymer sheet 130 can be used to fabricate a sheet which is used to fabricate yet another sheet and so on. In some embodiments, one of these negative or positive replicas may be used as a master for producing additional sheets (e.g. product). Either or both of the first polymer sheet 116 or the second polymer sheet 130, as well as any copies thereof, may be metalized in certain embodiments. Accordingly, the processes herein may be used to form tools or products as well as intermediate structures.

As discussed above, FIG. 7B is a schematic drawing that shows the first and second polymerized sheets 116, 130 are thick and narrow. These sheets 116, 130, however, may be thin. More generally these first and second sheets 116, 130 may have any shape and any dimensions. The polymer sheets 116, 130 may comprise, for example, a film, a plate, or a thicker component and may be curved or shaped.

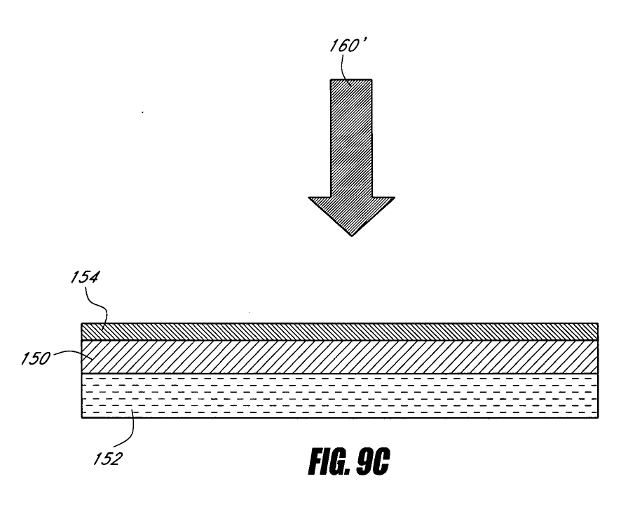

The second polymerized sheet 130 may be substantially optically transmissive to visible wavelengths and may be used as an optical component for controlling the propagation of light. FIG. 8 shows an embodiment of a display 142 comprising a spatial light modulator 144 for viewing by a viewer 146. The spatial light modulator 144 may comprise, for example, a liquid crystal display (LCD). The spatial light modulator 144 is backlighted by a backlighting system as represented by arrow 147. The display 142 further comprises a prismatic film 148 that controls the propagation of light to the spatial light modulator 144. This prismatic film 148 may comprise the second polymer sheet 130 shown in FIG. 7B. As described above, this second polymer sheet 130 comprises a plurality of sloping or inclined faces that form the facets of micro-prisms. These facets totally internally reflect a portion of the light incident on and propagating through the prismatic film 148. These facets also transmit another portion of light incident on and propagating through the prismatic film 148. As shown, the facets refract a substantial portion of the light that is transmitted through the prismatic film 148 into a range of angles, θ. This range of angles does not exceed a maximum angle θₘₐₓ. Accordingly, the prismatic film 148 limits the angle at which a substantial portion of the light is directed propagated through the spatial light modulator 144 to the viewer 146 and thereby substantially limits the field-of-view of the display 142.

Also, as described above, this second polymer sheet 130 comprises a plurality of localized surface relief features 140 that diffuse light transmitted through the prismatic film 148. In the embodiment shown, the surface relief features 140 are elliptically shape and may diffract light into an elliptically shaped divergent beam. The spatial light modulator 144 comprises a plurality of pixels arranged in rows and columns. The juxtaposition of plurality of linear grooves with respect to the rows and columns of pixels may produce a Moiré pattern. The diffusing surface relief features 140, which may scatter and diffract the light, reduce this effect. The diffusing surface relief features 140 may have different sizes, shapes, orientations, and distributions and may be arranged or configured differently. These surface relief features 140 form a diffusing texture that is superimposed on the surface relief structure 133 that form the micro-prisms of the prismatic film 148.

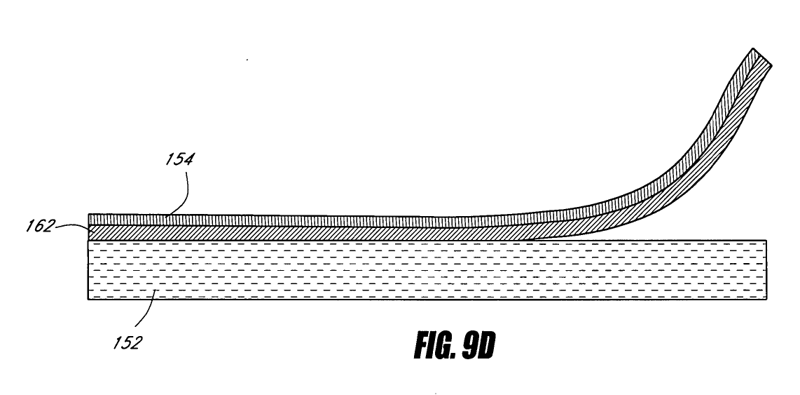

The photo-polymerization process may be implemented in a wide variety of ways. FIG. 9A shows one embodiment wherein a pre-polymerized liquid 150 is disposed over a rigid surface 152. This rigid surface 152 may be substantially smooth or may have a surface relief texture (e.g. roughened, patterned, etc.). In some embodiments this surface 152 comprises glass. The pre-polymer liquid 150 comprises monomers, oligomers, or a combination of monomers and oligomers.

A substrate carrier 154 is rolled out over the rigid surface 152 with the pre-polymerized liquid 150 therebetween. The substrate carrier 154 may comprise, e.g., polyethylene terephthalate (PET). The pre-polymerized liquid 150 is also rolled out by action of rolling out the substrate carrier 154. A roller 156 is shown in FIG. 9A rolling out the substrate carrier 154. The pre-polymerized liquid 150 and the substrate carrier 154 are between the rigid surface 152 and the roller 156. Other configurations are possible.

A mask 158 is disposed over the substrate carrier 154 as shown in FIG. 9B. The pre-polymerized liquid 150 is exposed by UV light represented by arrow 160 to cure the pre-polymerized liquid. The UV light passes through apertures (not shown) in the mask 158. The substrate carrier 154 is optically transmissive to the UV light that is used to cure the pre-polymerized liquid 150. Although the mask 158 is shown separated from the pre-polymerized liquid 150, the mask may contact the liquid in some embodiments. Such a configuration may provide higher resolution patterning in some embodiments.

As shown in FIG. 9C, the mask 158 is removed and the pre-polymerized polymerized liquid 150 is again exposed by UV light represented by arrow 160′ to cure the remaining uncured pre-polymerized liquid. The pre-polymerized liquid 150 is thereby transformed into a polymer layer 162 shown in FIG. 9D. Although the pre-polymerized liquid 150 is shown as being illuminated from above, the UV light may be directed from below as well regardless of whether the preceding expose with the mask 158 was from above or below. In some embodiments, UV light may be directed from both sides at different times or simultaneously. In cases where the light is to be propagated through the rigid surface, the rigid surface is preferably substantially optically transmissive to the wavelength of light used to cure the pre-polymerized material. Also, although the mask 158 is shown above the pre-polymerized liquid 150, the mask may alternatively be located below the pre-polymerized liquid. Similarly, UV light 160 can be directed from below the pre-polymerized liquid, through the rigid surface 152. In such embodiments, the rigid surface 152 may be substantially optically transmissive to UV light.

FIG. 9D shows the polymer layer 162 together with the substrate carrier 154 being separated from the rigid surface 152. The polymer layer 162 contains surface relief structure corresponding to the texture (if present) in the rigid surface 152. The polymer layer 162 also contains surface relief features corresponding to the apertures in the mask 158 as described above. The height of the surface features can be increase by washing the surface with a chemical wash comprising, for example, a solvent such as methanol. Other washes can also be used to enhance the modulation effect. These surface relief features may range in height from 10 nanometers to 1 millimeter in some embodiments although values outside this range are possible.

Certain parameters, such as the thickness of layer of pre-polymerized liquid 150 can affect the height of the surface relief features. Increased thickness of the pre-polymerized liquid 150 permits more monomer and oligomer molecules to migrate. The sharpness of the edges that define the surface relief features can also be influenced by certain parameters such as the length of time the pre-polymerized liquid is exposed to the UV light, the thickness of the substrate carrier 154, the thickness of the pre-polymerized liquid 150, as well as the material properties (for example, some formulations may include monomers and oligmers that migrate more or less than others).

As described above, UV light is not necessary for curing the curable material. Other wavelengths, for example, may be used. Other types of curable material may also be used.

The configuration may vary. For example, the curable material may be disposed on the tool or the tool may be disposed over the curable material. In some embodiments, first and second tools may be disposed over and under the curable material. The tool may be substantially optically transmissive to the electromagnetic radiation used to cure the curable material and the electromagnetic radiation may be passed through the tool to expose the curable material. The curable material may also be cured from the opposite side of the curable material such that the electro-magnetic material need not propagate through the tool and the tool need not be optically transmissive to the wavelength of light used for curing. Likewise, surface relief structure formed in one or more tools may be on one or both sides of the polymer sheet. Similarly, surface relief features in one or more masks may be on one or both sides of the polymer sheet.

As discussed above, a surface having surface relief structures may contact the curable material to introduce surface relief structure into the polymer sheet. In some embodiments, one or more surfaces that are substantially devoid of surface relief structure, e.g., are substantially flat, may contact the curable material. The electromagnetic radiation may propagate through this surface in some embodiments, and thus this surface may be substantially optically tranmissive to the electro-magnetic radiation. Pressure of this surface against the polymer sheet after the curing has been completed may suppress the formation surface features until the surface separated from the polymer sheet. After separation, the topographical changes may occur. If the surface is not removed, as in the case of the substrate carrier 154 depicted in FIGS. 9A-9D, the surface features will not form on the side of the polymer layer 162 with the surface of the substrate carrier 154 remaining in contact with the polymer sheet. In the embodiment, shown in FIGS. 9A-9D, the surface features may form on the side of the polymer layer 162 opposite to the substrate carrier 154 after the polymer layer is separated from the rigid surface 152. Similarly, the tool may apply pressure to the polymer sheet and suppress the formation of the surface features until removal of the tool.

Although a two stage photo-polymerization process has been described above, wherein curable material is exposed to UV light with and without a photomask, other embodiments may employ additional exposure steps. For example, a first mask may be disposed with respect to the cureable material and electromagnetic radiation transmitted therethrough. The first mask may be removed and a second mask may be disposed with respect to the curable material and the electromagnetic radiation may be transmitted therethrough. A third blanket exposure may follow. In other embodiments more masks and more exposures may be used.

Still other arrangements for exposing localized portions of the curable material are possible. In other embodiments, for example, an imaging system that projects an image may be employed instead of the mask. A laser may also be used as a light source. In some embodiments, laser scanning may be employed. In various embodiments, a laser can be used not for the interference properties of the coherent light produced but as a highly controlled bright light source (e.g., non-interferometrically). Still other configurations are possible.

More generally, the methods described herein may vary. One or more steps may be added or removed. The order of the steps may be changed.

Similarly, the structures produced may be different. The surface relief structures and localized surface relief features may have different configurations, patterns, or arrangements. The dimensions may also be different. Also as describe above, polymer surfaces, layers, films, sheets, or other structures may be formed using the processes described herein. Additional surfaces, layers, films, or components may be added. Items may be removed as welt or ordered, positioned, oriented, or arranged differently. For example, the carrier substrate may be excluded in certain embodiments. Similarly one ore more layers may be disposed between any of the layers, e.g., carrier substrate, pre-polymerized material, tool, described above. Other variations are also possible.

As described above, the processes described herein may be used to fabricate optical elements such as diffusers and prismatic films. Diffraction gratings and diffractive optical elements as well as holograms and holographic optical elements may be fabricated. For example, the processes described herein may be used to form surface relief structure and surface relief features that diffract light to produce the desired diffractive and/or holographic effects. Such diffractive or holographic optical elements may be transmissive or reflective. The processes described herein may also be used to fabricate total internal reflection elements.

In one exemplary embodiment, a prismatic film that includes diffusing features may be formed to provide control over the properties of a display. For example, the field-of-view may be restricted. Additionally, the brightness of the display may be enhanced for a range of angles. Such optical components may be used, e.g., for computers, televisions cell phones, personal digital assistants (PDAs), games, automobile and navigational instrumentation, and for other applications. For example, the processes describe herein can be used for micro-electro-mechanical systems (MEMS) and microfluidics. Still other applications are possible. In some embodiments the polymer sheet produced is not an optical element.

Various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of manufacturing a polymer sheet having surface relief features, comprising:
depositing a layer of fluid over a first surface, said fluid comprising a pre-polymer material comprising monomers, oligomers, or a mixture of monomers and oligomers;
first exposing a plurality of spatially separated locations on said fluid to light such that the pre-polymer material locally cures and substantially solidifies at said locations, a portion of said monomers, oligomers, or monomers and oligomers in said pre-polymer material migrating to said locations from regions outside said locations; and
second exposing the fluid such that said regions outside said locations are cured and substantially solidified,
wherein said curing produces said polymer sheet having said surface relief features, and said surface relief features are at said locations.

2. The method of claim 1, wherein the pre-polymer material comprises monomers.

3. The method of claim 1, wherein the pre-polymer material comprises oligomers.

4. The method of claim 3, wherein the pre-polymer material comprises monomers and oligomers.

5. The method of claim 1, wherein said first exposing step comprises propagating the light through a mask.

6. The method of claim 5, further comprising removing said mask prior to said second exposing step.

7. The method of claim 5, wherein said mask is disposed on a first side of said layer of fluid and said second exposure step comprises illuminating a second side of said layer of fluid with light.

8. The method of claim 1, wherein the light comprises ultraviolet or actinic light.

9. The method of claim 1, wherein in said second exposing step, said plurality of spatially separated locations and said regions outside said locations are exposed to the light.

10. The method of claim 9, wherein said second exposing step comprises a blanket exposure of said layer of fluid such that substantially all of said pre-polymer material is cured and solidified upon completion of said second exposing step.

11. The method of claim 1, wherein said first surface has surface relief structure that forms corresponding surface relief structure in said polymer sheet.

12. The method of claim 11, wherein a mask is disposed on a first side of said fluid and said first surface with said surface relief structure is disposed on a second side of said fluid.

13. The method of claim 11, further comprising a mask, said first surface with said surface relief structure disposed between said mask and said fluid.

14. The method of claim 1, further comprising sandwiching said fluid between said first surface and a second surface, said second surface being on a carrier substrate.

15. The method of claim 14, further comprising removing said fluid from said first surface after said second exposing step.

16. The method of claim 15, wherein said light is propagated through said first surface.

17. The method of claim 15, wherein said light is propagated through said carrier substrate.

18. The method of claim 14, wherein said first surface has surface relief structure that contacts said curable material.

19. The method of claim 1, further comprising forming a master from said polymer sheet, said master having surface relief features corresponding to said surface relief features in said polymer sheet.

20. The method of claim 19, further comprising forming a product with said master, said product comprising surface relief features corresponding to said surface relief features in said master.

21. The method of claim 20, further comprising metalizing said product such that said product is reflecting.

22. The method of claim 20, further comprising including said product in a display comprising a spatial light modulator and a light source disposed with respect to said spatial light modulator to backlight said spatial light modulator.

23. The method of claim 22, wherein said surface relief features in said product are optically diffusing.

24. The method of claim 23, further comprising forming a plurality of grooves in said product with said master to form a plurality of prisms having facets, said facets including said optically diffusing surface relief features.

25. A method of manufacturing a polymer sheet having surface relief features, comprising:
providing a layer of fluid comprising curable material, said layer of fluid having a surface;
altering the height of the surface of the layer of fluid at spatially separated locations relative to the surrounding surface such that the locations correspond to the position of the surface relief features, said altering comprising curing the curable material at the locations differently than the surrounding surface.

26. The method of claim 25, wherein said curable material at both said spatially separated locations and the surrounding surface is cured until said curable material is substantially completely polymerized.

27. The method of claim 25, wherein said curable material at both said spatially separated locations and the surrounding surface is cured until said curable material is solidified.

28. The method of claim 25, wherein said curing the curable material at the locations differently comprises curing the curable material at the locations at a different time than the surrounding surface.

29. The method of claim 25, wherein said curing the curable material at the locations differently comprises directing an optical intensity pattern on said surface to illuminate said locations and altering said optical intensity pattern to cure said surrounding surface.

30. The method of claim 25, wherein the curable material comprises monomers.

31. The method of claim 25, wherein the curable material comprises oligomers.

32. The method of claim 31, wherein the curable material comprises monomers and oligomers.

33. The method of claim 25, wherein said curing comprises exposing said curable material to light.

34. The method of claim 33, further comprising propagating said light though a mask to cure said fluid at spatially separated locations.

35. The method of claim 34, further comprising contacting said mask to said layer of fluid.

36. The method of claim 25, wherein the height of the surface of the layer at said spatially separated locations differs by between about 10 nanometers and 100 micrometers relative to the surrounding surface.

37. The method of claim 25, further comprising causing migration of monomers, oligomers, or monomers and oligomers in said curable material to said the spatially separated locations from said surrounding surfaces.

38. The method of claim 25, further comprising washing the surface with a chemical to further alter said height of the surface of the layer at said spatially separated locations relative to the surrounding surface.

39. The method of claim 38, wherein said chemical comprises a solvent that etches polymer.

40. The method of claim 38, wherein said chemical comprises methanol.

41. The method of claim 25, wherein said surface relief features form a diffractive optical pattern that forms a diffractive optical element when replicated in a transmissive medium or reflective surface.

42. The method of claim 25, wherein said surface relief features form an optical pattern that forms an elliptical diffuser when replicated in a transmissive medium or reflective surface.

43. The method of claim 25, further comprising forming a master from said polymer sheet, said master having surface relief features corresponding to said surface relief features in said polymer sheet.

44. The method of claim 43, further comprising forming a product with said master, said product comprising surface relief features corresponding to said surface relief features in said master.

45. The method of claim 44, further comprising metalizing said product such that said product is reflecting.

46. The method of claim 44, further comprising including said product in a display comprising a spatial light modulator and a light source disposed with respect to said spatial light modulator to backlight said spatial light modulator.

47. The method of claim 46, wherein said surface relief features in said product are optically diffusing.

48. The method of claim 47, further comprising forming a plurality of grooves in said product with said master to form a plurality of prisms having facets, said facets including said optically diffusing surface relief features.

49. A method of manufacturing a polymer sheet having a contoured surface, comprising:
providing a layer of curable material;
forming a first set of surface relief structures in said layer by contact;
producing a second set of surface relief features in said layer by optically curing the curable material, said curing of material at locations corresponding to the surface relief features being different than said curing outside of said locations; and
selecting the first set of surface relief structures and the second set of surface relief features to provide different optical effects when corresponding surface relief structures and surface relief features are formed in a transmissive medium or reflective surface.

50. The method of claim 49, wherein the curable material comprises a liquid.

51. The method of claim 49, wherein the curable material comprises monomers.

52. The method of claim 49, wherein the curable material comprises oligomers.

53. The method of claim 52, wherein the curable material comprises monomers and oligomers.

54. The method of claim 49, wherein curing said curable material comprises exposing said curable material to electromagnetic energy.

55. The method of claim 49, further comprising forming a master from said polymer sheet.

56. The method of claim 55, further comprising forming an optical product with said master.

57. The method of claim 56, further comprising forming at least one intermediate element to form said optical product.

58. The method of claim 49, wherein said positive or negative copies of said surface relief structures and said surface relief features form prismatic structures and diffusing surface texture, respectively, when produced in a transmissive medium or in a reflective surface.

59. The method of claim 49, wherein said surface relief features are selected to form an elliptical diffuser when positive or negative copies of said surface relief features are formed in a transmissive or reflective medium, said elliptical diffuser producing a substantially elliptical beam when illuminated with substantially collimated light.

60. The method of claim 49, wherein said surface relief features are selected to form a circular diffuser when positive or negative copies of said surface relief features are formed in a transmissive or reflective medium, said circular diffuser producing a substantially circular beam when illuminated with substantially collimated light.

61. The method of claim 49, further comprising forming a master from said polymer sheet, said master having surface relief features and surface relief structure corresponding respectively to said surface relief features and said surface relief structure in said polymer sheet.

62. The method of claim 61, further comprising forming a product with said master, said product comprising surface relief features and surface relief structure corresponding respectively to said surface relief features and said surface relief structure in said master.

63. The method of claim 62, further comprising including said product in a display comprising a spatial light modulator and a light source disposed with respect to said spatial light modulator to backlight said spatial light modulator.

64. The method of claim 63, wherein said surface relief features in said product are optically diffusing.

65. The method of claim 64, wherein said surface relief structures comprises a plurality of prisms having facets, said facets including said optically diffusing surface relief features.
